(19) United States
(12) Patent Application Publication
(10) Pub. No.: US 2004/0159189 A1
(43) Pub. Date: Aug. 19, 2004

(54) Striking and removal implement utilizes a weight for dual function

(76) Inventor: Timothy C. Luton, Montague, CA (US)

Correspondence Address: Timothy C. Luton, P.O. Box 654, Montague, CA, 96064, US

(21) Appl. No.: 10/366,682

(22) Filed: Feb. 14, 2003

(51) Int. Cl. B25D 1/00

(52) U.S. Cl. 81/20

(57) ABSTRACT

A striking and removal implement having a head (10), comprising a specially designed striking surface, two special fingers opposite, a void at center for receiving handle (12). A weight (14) with an eyelet allows a strap (16) to be inserted through and secure said weight (14) at the back side of said receiver when said weight (14) is utilized.

### BACKROUND

1. Field of Invention

This invention relates to a tool for striking and removing fasteners, having a dual function in the fields of finish and of rough carpentry.

2. Description of Prior Art

In the patent of Coonrad, U.S. Pat. No. 5,988,019, the abstract mentions variable systems, one having to do with weight, wherein, is vaguely present in the claims and brings forward the safety concerns associated with many of the prior inventions, it should not have any validity on the above patent.

The patent of Gierer, U.S. Pat. No. 6,016,722, wherein a shock-absorbing claw hammer having a plug dampening the shock does not add to the utility, rather, is minimal advance in ease in extended usage per interval. This patent has no bearing on the above named current embodiment.

The invention of Hedelin, U.S. Pat. No. 5,992,270, utilizes a different aproach and may actually give way and weaken the relationship of the shaft and head over a period of time, as the force of striking fasteners may have a crushing effect. This patent should not hold any weight concerning the above named patent.

A hammer with accessories is named in the patent of Bulcock, U.S. Pat. No. 6,088,862, wherein several add-on implements are installed for specific purposes and multiple functions. A level utilizing a fluid as is standard, may be jeopardized while striking, through deflection, and/or misaligned. The hammer acts as a frame for housing multitask implementation, a question concerning the strength of the hammering aspect causes me to use caution. This product does not interfere with the present embodiment in the above named patent.

In the patent of Atkinson, U.S. Pat. No. 6,032,927, wherein a hook has been placed so as to grip a nail in an unconventional manner, would limit accessibility if the hammer had to be navigated sideways, by the bulk of the hammers opposite ends. Typically a claw on a hammer is used side to side when removing fasteners, saving the relationship of the head and handle by reducing stress as the force utilized is greatly reduced.

In the patent of Simpson, U.S. Pat. No. 5,575,029, relaying implements added to further the fields it may be used in, although, hammering and these other functions are remote to each other, and would probably be better served by well designed, ready manufactured tools occupying their existing markets. This patent should have no bearing on the above named patent.

The patent of Fisher, U.S. Pat. No. 4,030,150, wherein additional supplements designed to create a combination of several tools, relaying no improvements to the hammering aspect of the embodiment, rather, a quantitative assembly of goods attached thereto.

### OBJECTS AND ADVANTAGES

Accordingly, besides the objects and advantages of the striking and removal implement described in the above patent, several objects and advantages are:

(a) one tool can be carried in the tool belt, from interior to exterior, the same having the ability to perform either finish or rough hammering utilizing the proper fastener, simply, by adding, or, removing a formulated weight;

(b) the secured weight fits to the backside of the specially designed receiver below the claw portion, out of danger, though, allowing the full function of the remaining areas to their specified tasks;

(c) the present embodiment of the above patent application relays a positive improvement in its related field of striking and removal implements relating to the ease of use and the ease of conversion between various phases in carpentry or construction;

(d) the present embodiment of the above patent application relays well known elements in its operation, yet, the implementation will yield new and useful results, unobvious to those previously possessing the knowledge to make it.

### DRAWING FIGURES

FIGS. 1-3 shows various aspects of the specially designed striking/removal head (10) with weight (14) and strap (16) for an overall view of some details pertaining to these elements.

FIG. 1-3 shows further details of recessed waffle in head (10) and mounting area for weight (14) and its eyelet for accepting strap (16) and details of the removal portion.

FIG. 4 shows weight (14) installed in the cradle at the receiver portion of head (10) secured by strap (16) and details of handle (12).

### DRAWING REFERENCE NUMERALS

10 Head

12 Handle

14 Weight

16 Strap

Description—FIGS. 1-4

FIG. 1 shows details of three elements wherein it relays details of the recessed waffle at the striking surface, the curved and cradle areas forward and aft of the receiver and typical removal implementation with improvements in head 10.

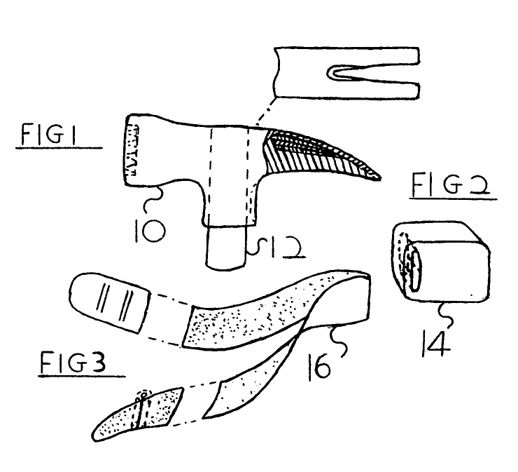

FIG. 2 shows details of weight 14, while FIG. 3 shows a rolled out end of strap 16 shows details of the leather latch. At the opposite end, two strips form loops across its width, the outermost for maintaining the connection wherein strap 16 can be removed by sliding it off of handle 12 without filly separating the ends, the inner is for inserting and locking the latch holding weight 14 tight in its cradle when installed.

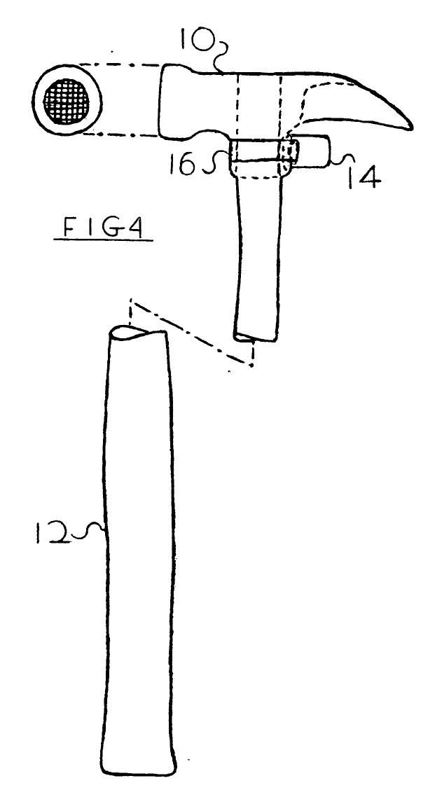

A typical embodiment of the present invention illustrated in FIG. 4 shows a striking/removal head 10 with handle 12 in place and weight 14 as it is secured by strap 16 and the relationship of each when applied for duality.

Operation—FIGS. 1-4

The manner of using the main embodiment of the striking and removal implement without the addition of weight 14 is well known and is commonly used in finish carpentry This invention can be utilized in both finish and rough by simply slipping handle 12 through strap 16 moving weight 14 into position into its cradle, then feed the latch through the innermost loop locking weight 14 tight in position.

### SUMMARY, RAMIFICATIONS, AND SCOPE

The present embodiment of the above patent application relays certain functions consistent to the field of striking and removal tools with one major difference. The embodiment of this particular invention will covert a tool with shared properties of a finish hammer to a tool consistent to perform heavier task's, such as those associated with rough carpentry or framing and will have broad appeal as its utility is introduced to the public while being recognized as a safe, reliable and durable implement for the home owner as well as home builders. Furthermore, additional advantages are recognized in that;

a piece of velcro can be added to the strap for additional ease and comfort to the user;

the striking face with a limited waffled surface existing inside and flush to the main area for striking will help prevent scaring, adding to its appeal; and

with the weight added, due to the nontraditional configuration on the striking face, the tool would not allow the striking face to glance off the head of fasteners.

Although the description above contains many specifities, these should not be construed as limiting the scope of the invention but as merely providing illustrations of the present preferred embodiment.

The scope of the invention should be determined by the appended claims and their legal equivalents, rather than the examples given.

1. A striking and removal implement, having a striking surface and a removal portion opposite with a handle at a right angle attached inside a void near center, utilizes an attachable weight placed on the underside below the removal portion and secured by a strap just above the handles lowest intersection with said void, for dual function.

2. The striking face of claim 1 differs from traditional household hammers, wherein a recessed waffled area rest's flush with the striking face.

3. The removal portion of claim 1 wherein, two adjacent fingers are placed to allow misplaced or broken and bent fasteners to be retrieved, a shallow end exist's having an additional raise at the innermost region for gripping fasteners.

4. The striking and removal portion of claim 1 wherein, a void exists for receiving a handle to be attached inside and having special elongated areas directly below the striking and removal areas forming a strap guide at front and a weight cradle at rear.

5. The handle portion of claim 1 is appropriated in size and length to the differentiation between task's.

6. The strap portion of claim 1 is specially formulated to maintain a continuous band with the latch remaining between the two loops and permanently installed through the eyelet of said weight.

7. The specially designed weight portion of claim 6 wherein the measured proportion of material relating to it's size, shape and influence reflect the desired outcome when said weight is attached for duality.
